(19) United States
(12) Patent Application Publication
(10) Pub. No.: US 2024/0116168 A1
(43) Pub. Date: Apr. 11, 2024

(54) Layout Tool Devices and Systems

(71) Applicant: Milwaukee Electric Tool Corporation, Brookfield, WI (US)

(72) Inventors: Samuel A. Gould, West Allis, WI (US); Danielle K. Quan, Milwaukee, WI (US); Todd P. Kusik, Wauwatosa, WI (US); John J. Rymsza, Wauwatosa, WI (US); John S. Scott, Brookfield, WI (US); Gareth J. Mueckl, Milwaukee, WI (US); Richard M. Schieber, Milwaukee, WI (US); Samuel B. Petre, Brookfield, WI (US)

(21) Appl. No.: 18/493,511

(22) Filed: Oct. 24, 2023

Related U.S. Application Data
(63) Continuation of application No. PCT/US23/76439, filed on Oct. 10, 2023.
(60) Provisional application No. 63/379,076, filed on Oct. 11, 2022.
(60) Provisional application No. 63/385,090, filed on Nov. 28, 2022.

(51) Int. Cl. B25H 7/00

(52) U.S. Cl. CPC B25H 7/00

(57) ABSTRACT

Various embodiments of layout tool devices and systems are provided. In various embodiments, the layout tool devices and systems improve layout work flow using layout tools, such as via using lasers and/or customized flexible elongate structures to facilitate marking points along a line, including systems with multiple devices, such as mobile devices, that emit lasers in combination with the other devices in the system.

### CROSS-REFERENCE TO RELATED PATENT APPLICATIONS

The present application is a continuation of International Application No. PCT/US2023/076439, filed Oct. 10, 2023, which claims the benefit of and priority to U.S. Application No. 63/385,090, filed Nov. 28, 2022, and U.S. Application No. 63/379,076, filed Oct. 11, 2022, each of which is incorporated herein by reference in its entirety.

### BACKGROUND OF THE INVENTION

The present disclosure is directed generally to the field of tools. The present disclosure relates specifically to layout tool devices and systems.

### SUMMARY OF THE INVENTION

Various embodiments of the invention relate to layout tool devices and systems designed to improve efficiency, accuracy, ease, etc. of performing layout tasks.

One embodiment of the invention relates to a laser layout system including a first device and a second device. The first device includes a laser generation device and a camera. The laser generation device is configured to emit a first laser beam downward at a lower surface and a second laser beam upward at an upper surface. The second device includes a display screen and a receiver. The receiver is configured to receive a signal from the first device that is representative of an image captured by the camera, and the display screen is configured to display the image captured by the camera in response to receiving the signal.

Another embodiment of the invention relates to a first device including a laser generation device and a camera. The laser generation device is configured to emit a first laser beam downward at a lower surface and a second laser beam upward at an upper surface. The camera is configured to capture an image of the first laser beam intersecting the lower surface. The second device is configured to wirelessly send a signal to the first device to adjust the first laser beam. The first device is configured to adjust the aim of the first laser beam in response to the first device receiving the signal.

Another embodiment of the invention relates to a laser layout system including a moveable vehicle including a base and a platform that vertically actuates above the base between an extended position and a retracted position, a first device coupled to the base, and a second device communicably connected with the first device. The platform is further above the base in the extended position compared to the retracted position. The first device includes a laser generation device configured to emit a first laser beam downward and a second laser beam upward. The second device is coupled to the platform.

Another embodiment of the invention relates to a laser measuring system. The system includes a first device including a first housing and a first laser generation device coupled to the first housing, the first laser generation device configured to emit a first laser beam, and a second device including a second housing, a second laser generation device coupled to the second housing, the second laser generation device configured to emit a second laser beam. In various embodiments the devices are configured to detect the laser beam emitted by the other device and to project intervals on the floor between the devices. In various embodiments, the system includes a mobile device configured to move between the first device and the second device along a laser line projected by one of the first device and/or the second device.

Another embodiment of the invention relates to a measuring device including a housing defining a compartment and an aperture providing fluid communication between the compartment and outside the housing, and a flexible elongate structure extending along a longitudinal axis that is at least partially stored within the compartment and extends out of the compartment via the aperture. During use, the flexible elongate structure is pulled out of the compartment and retracted within the compartment via the aperture. The flexible elongate structure defines a plurality of mark points (e.g., knots in a string) at a repeating interval along the flexible elongate structure, the plurality of mark points extending outward from a plurality of portions extending between the mark points. The device includes a marking material (e.g., chalk) that adheres to the flexible elongate structure.

Another embodiment of the invention relates to a measuring device including a first housing, a first laser generation device coupled to the first housing, a second housing slidably coupled to the first housing, a second laser generation device coupled to the second housing, a clamp coupled to the first housing to rigidly secure the first housing to an object, and a distance indicator coupled to at least one of the first housing and the second housing. The distance indicator indicates a distance between the first laser generation device and the second laser generation device.

Another embodiment of the invention relates to a measuring system including a first device including one or more laser generation device(s) and a camera, a first laser generation device of the laser generation device(s) configured to emit a first laser beam vertically downward and a second laser beam vertically, and a second device including a screen and a receiver. The receiver is configured to receive signals from the camera and communicate the signals to the screen. The screen is configured to display an image captured by the camera in response to receiving the signals.

Another embodiment of the invention relates to measuring device including a housing defining a compartment, and a flexible elongate structure at least partially stored within the compartment. In use, the flexible elongate structure is pulled out of the compartment and retracted within the compartment. The flexible elongate structure defines a plurality of apertures including a first aperture, a second aperture, and a third aperture. The first aperture is a first distance from an end of the flexible elongate structure, the second aperture is a second distance from the end, and the third aperture is a third distance from the end. The second distance is approximately 2\hat{ }0.5 longer than the first distance, and the third distance is approximately 2\hat{ }0.5 longer than the second distance.

Another embodiment of the invention relates to a measuring device including a housing defining a compartment, a flexible elongate structure at least partially stored within the compartment. In use, the flexible elongate structure is pulled out of the compartment and retracted within the compartment. The flexible elongate structure includes a plurality of light-emitting elements coupled to the flexible elongate structure. The measuring device also includes a plurality of input buttons coupled to the housing, the input buttons being configured to control which of the light-emitting elements are turned on such that a first subset of the light-emitting elements emit light and a second subset of the light-emitting elements distinct from the first subset does not emit light.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a first laser measuring system, according to an exemplary embodiment.

FIG. 2 is a side view of the laser measuring system of FIG. 1 in use, according to an exemplary embodiment.

FIG. 3 is a perspective view of a second laser measuring system, according to another exemplary embodiment.

FIG. 4 is a top schematic view of the laser measuring system of FIG. 3 in use, according to an exemplary embodiment.

FIG. 5 is a perspective view of a third laser measuring system, according to another exemplary embodiment.

FIG. 6 is a top schematic view of the laser measuring system of FIG. 5 in use, according to an exemplary embodiment.

FIG. 7 is a side view of a measuring device, according to an exemplary embodiment.

FIG. 8 is a side view of an extendable pole, according to an exemplary embodiment.

FIG. 9 is a detailed view of the extendable pole of FIG. 8, according to an exemplary embodiment.

FIG. 10 is a side view of a laser layout system, according to another exemplary embodiment.

FIG. 11 is a detailed view of a device of the laser layout system of FIG. 10, according to an exemplary embodiment.

FIG. 12 is a detailed view of another device of the laser layout system of FIG. 10, according to an exemplary embodiment.

FIG. 13 is a side view of a measuring device, according to another exemplary embodiment.

FIG. 14 is a schematic top view of measurements made by the measuring device of FIG. 13, according to an exemplary embodiment.

FIG. 15 is a detailed schematic top view of measurements made by the measuring device of FIG. 13, according to an exemplary embodiment.

FIG. 16 is a side view of a measuring device, according to another exemplary embodiment.

### DETAILED DESCRIPTION

Referring generally to the figures, various embodiments of layout tool devices and systems are provided. In various embodiments, the layout tool devices and systems shown in the FIGS. and described herein improve layout work flow using layout tools, such as various laser level devices. For example, the devices and systems described herein facilitate users marking points, such as installation points, across a surface, such as floors or ceilings.

In various embodiments, a laser measuring system is provided that includes two or more devices that include laser generation devices, and a mobile device. The mobile device is configured to move and/or be moved between the two or more devices. The two or more devices are configured to be positioned around an area to facilitate marking locations, such as for installation of objects.

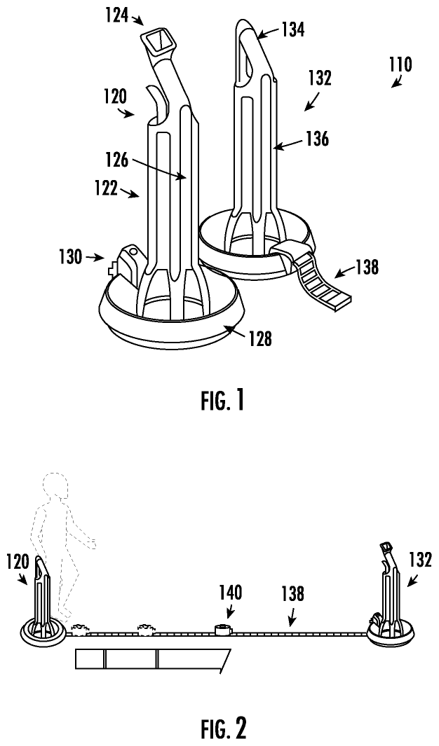

Referring to FIGS. 1-2, various aspects of laser measuring system 110 are provided. Laser measuring system 110 includes first tower 120, second tower 132, and carriage 140. Carriage 140 is configured to move under its own power and/or be moved (e.g., by one of the towers) between the towers.

First tower 120 includes a body 122, a handle 124 coupled to body 122, a laser generation device 126 configured to emit a laser beam (e.g., a point laser beam and/or a plane laser beam), and a base 128 rotatably coupled to body 122 (e.g., base 128 can rotate 360 degrees relative to body 122). In various embodiments, first tower 120 is configured to emit the laser beam at an upper surface, such as a ceiling. After a user rotates base 128 to the desired orientation with respect to body 122, the user can actuate lock 130 to secure base 128 relative to body 122 such that base 128 no longer rotates with respect to body 122.

In various embodiments, body 122 and/or base 128 have detents at certain angles (e.g., 30 degrees, 45 degrees, 60 degrees, 90 degrees, 145 degrees) to facilitate the user rotating the base 128 to those angles relative to the base. This provides the ability for users to quickly identify commonly-used angles from the towers. For example, if the user has a series of installation points along a first line, and a second series of installation points along a second line perpendicular to the first line (e.g., along a wall that has a corner), the user can quickly rotate the base 128 to identify the 90 degree angle and continue marking the second series of installation points.

In various embodiments, one or both of the towers have a distance measuring device to measure offsets from objects, such as a laser distance measurer. In various embodiments, neither of the towers have a distance measuring device to measure offsets from objects, such as a laser distance measurer. In various embodiments, such as digital embodiments, one or both of the towers include an encoder on a measuring device that provides the user, as the tower is moving, information identifying a distance and angle relative to the other tower, thereby helping the user position the tower at the correct angle and/or distance. In various embodiments, the distance measurement may be shown on a remote screen (e.g., such as subsequent to wireless communications).

Second tower 132 includes handle 134, laser generation device 136 configured to emit a laser beam (e.g., a point laser beam and/or a plane laser beam), and a track 138 coupled to second tower 132. In various embodiments, the flexible elongate structure, shown as track 138, is configured to facilitate carriage 140 being moved from first tower 120 to second tower 132.

In various embodiments, carriage 140 is automated, remote controlled, manually retracted between the towers, and/or is retracted by human and/or machine power. In various embodiments, carriage 140 has integrated markings and/or lasers for marking points for installation.

In use, a user sets first tower 120 at a point, and then user sets second tower 132 on another point and the two towers auto-align to each other (e.g., each tower adjusts where an emitted laser beam is aimed until the other tower detects the laser beam). The second tower 132 can be linked to the first tower, such as via track 138 extended between the towers.

After the carriage 140 has completed traversing from the first tower 120 towards the second tower 132, the user can reposition the first tower 120 at a new location, such as offset and at an angle from the first line between the first tower 120 and the second tower 132. Then, after the carriage has completed traversing from the second tower 132 to the first tower 120 at the new location, the user can again reposition the second tower 132, such as offset at and at an angle from the previous line between the towers. In this way, the user can mark installation points along multiple lines that may be either aligned or at a non-zero angle with respect to each other.

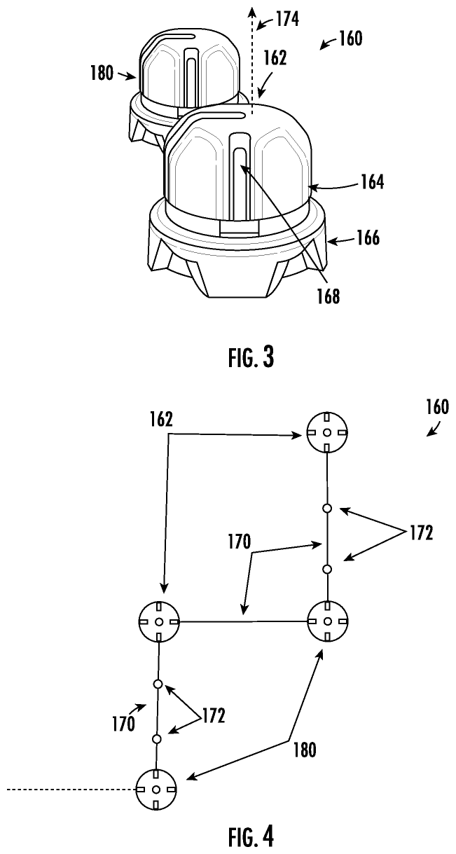

Referring to FIGS. 3-4, laser measuring system 160 is shown according to an exemplary embodiment. Laser measuring system 160 is substantially the same as laser measuring system 110 except for the differences discussed herein.

Laser measuring system 160 includes first device 162 and second device 180. First device 162 includes housing 164, base 166 coupled to housing 164, such as rotatably coupled, a laser generation device 168 that emits a laser beam line 170 and optionally one or more interval locations 172. In various embodiments, housing 164 is rotatably coupled to base 166 such that housing 164 is configured to rotate about axis 174 with respect to base 166. In use, first device 162 and/or second device 180 include a detector that facilitates auto-aligning the laser beams emitted by first device 162 and/or second device 180 after they have been placed at their desired locations.

Referring to FIG. 4, a schematic top view is provided of the process of a user daisy-chaining the devices relative to each other to install multiple lines of installation points.

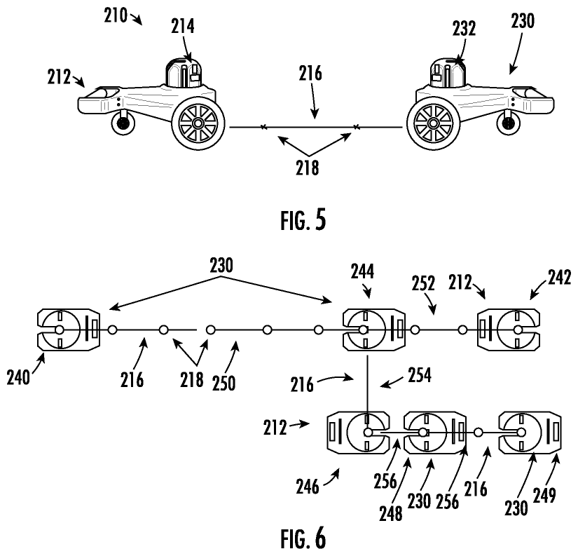

Referring to FIGS. 5-6, laser measuring system 210 is shown according to an exemplary embodiment. Laser measuring system 210 is substantially the same as laser measuring system 110 and laser measuring system 160 except for the differences discussed herein.

Laser measuring system 210 includes first device 212 and second device 230. First device 212 includes laser generation device 214. Second device 230 includes laser generation device 232. One or both of laser generation device 214 and laser generation device 232 are configured to emit a laser beam that forms laser beam line(s) 216, and that optionally also marks one or more interval locations 218. Laser beam line(s) 216 are aligned between first device 212 and second device 230.

First device 212 and second device 230 are mobile units that align, such as automatically align, with each other and the laser emitted by first device 212 and second device 230. In various embodiments, each of first device 212 and second device 230 includes laser emitting and marking capabilities (e.g., can emit laser beam(s) that form laser beam line 216) and can follow the laser beam of the companion device, whilst marking a laser line, such as on the ground.

In use, a user can arrange two devices at different points, such as first device 212 at location 242 and second device 230 at location 240. Then, first device 212 and second device 230 auto-align with each other such that second device 230 projects first line 250 towards first device 212, and first device 212 projects line 252 towards second device 230. In various embodiments, first device 212 and/or second device 230 include a detector that facilitates auto-aligning the laser beams emitted by first device 212 and/or second device 230 after they have been placed at their desired locations.

Then, second device 230 moves along lines 250, 252 towards first device 212 until second device arrives at location 244 near first device 212. Then, a user controls second device 230 to emit line 254 in the downward direction. Then, first device 212 is moved to location 246, such as via a user remotely controlling first device 212 to location 246 (e.g., via a remote control). Then, a user control first device 212 to emit line 256. Then, second device 230 is moved to location 248 and then location 249 along line 256. In this way, first device 212 and second device 230 engage cooperatively with each other to map out the intervals 248 on lines 216.

In use, a user can remotely control the first device 212 and second device 230 such that the first device 212 will traverse along a laser line provided by second device 230. As second device 230 traverses the laser line, second device 230 may mark the floor at intervals (e.g., intervals 218). When second device 230 arrives at the end of laser line 216 (e.g., at a predetermined distance from first device 212), the user and/or laser measuring system 210 will reposition the emitted laser to enable first device 212 to traverse the repositioned laser line. The first device 212 will traverse along the repositioned laser line and mark intervals.

In various embodiments, first device 212 and second device 230 are capable of auto-alignment of their respective laser to a detector or to another laser. In various embodiments, first device 212 and second device 230 have integrated marking capabilities, such as making a mark on the ground, such as forming or writing a line, at intervals.

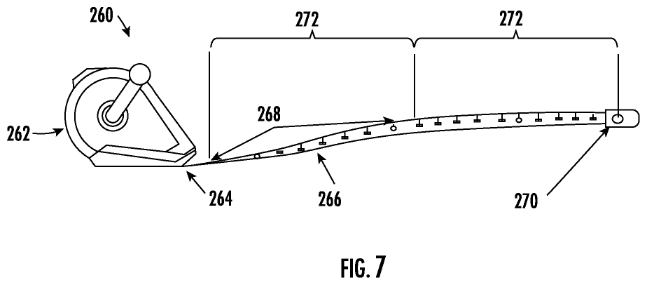

Referring to FIG. 7, measuring device 260 is shown according to an exemplary embodiment. Measuring device 260 includes a housing 262 defining an aperture 264 providing fluid communication between an internal storage compartment and outside the housing 262. A flexible elongate structure, shown as string 266, extends from compartment via the aperture 264. The string 266 includes a plurality of marking points, shown as knots 268, at intervals 272 along the string 266. The string 266 is coated with a marking material, such as chalk. When end 270 is extended from the housing 262 and subsequently string 266 is snapped against the ground, the knots 268 make a differentiated mark then the intervals 272 between the knots 268, thereby facilitating the user installing at those points. In various use cases, the differentiated mark may be lighter or darker than the surface being marked. For example, if the surface is dark, then the differentiated mark may be light, or at least lighter than the surface. As another example, if the surface is light, then the differentiated mark may be dark, or at least darker than the surface. In various embodiments, the knots 268 are configured to make a certain shape when string 266 is snapped against the surface.

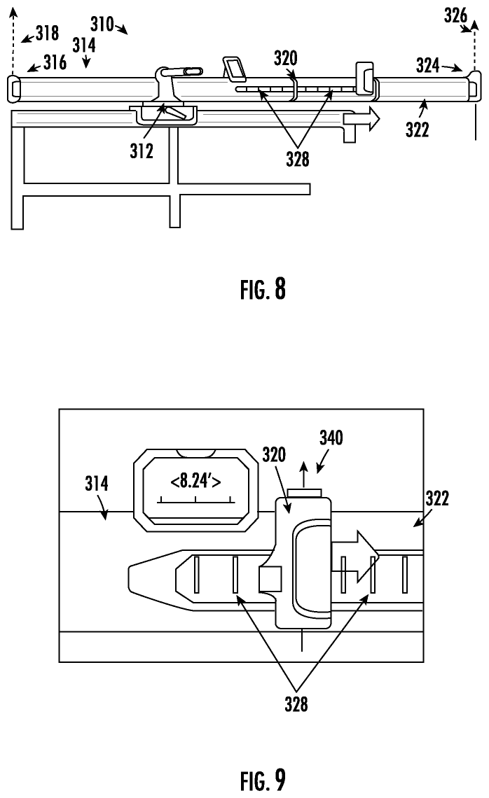

Referring to FIGS. 8-9, extendable pole 310 is shown according to an exemplary embodiment. Extendable pole 310 includes first housing 314, second housing 322 slidably coupled to first housing 314, and clamp 312 coupled to first housing 314, such as slidably coupled. A securing device, shown as clamp 312, is configured to secure extendable pole 310 to other objects such as a utility basket on a movable platform. In various embodiments the securing device, shown as clamp 312, may be a magnet, friction fit between the housings 314, 322, and/or a claw, which biases the housings 314, 322 to remain stationary with respect to each other. In various embodiments, clamp 312 being slidably coupled to first housing 314 ensures that the entire extendable pole 310 can be slid with respect to clamp 312. In various embodiments, clamp 312 is rotationally coupled to first housing 314, thereby permitting first housing 314 and second housing 322 to rotate with respect to clamp 312, thereby permitting the alignment of the entire extendable pole 310 to be oriented independently of the orientation of the object (e.g., a platform) that extendable pole 310 is coupled to. In various embodiments, clamp 312 is slidably coupled to the object that clamp 312 is coupled to, such as to a utility basket on a moveable platform.

First laser generation device 316, which emits first laser beam 318, is coupled to first housing 314. In various embodiments, first laser beam 318 is emitted as a line that is perpendicular to the length of housings 314, 322. In various embodiments, extendable pole 310 is paired with a vertical line laser on the ground that identifies a path for the user to follow, such as via a linear reference on an upper surface, such as a ceiling. Second laser generation device 324, which emits second laser beam 326, is coupled to second housing 322. In various embodiments, extendable pole 310 includes two or more housings that are coupled together, such as slidably coupled together. In various embodiments, a laser generation device is coupled to each of the three or more housings.

A distance indicator 320 is coupled to one of first housing 314 and second housing 322, and a series of measurements 328 are coupled to the other of first housing 314 and second housing 322. As first housing 314 and second housing 322 are slid with respect to each other, the positioning of distance indicator 320 relative to series of measurements 328 correspondingly also moves, thereby permitting the user to identify how far apart first laser beam 318 is from second laser beam 326. Extendable pole 310 includes a lock 340 to secure first housing 314 relative to second housing 322 once the user has selected the desired distance between the laser beams.

In use, the user extends the housings to the correct length. The user then optionally secures extendable pole 310 to a device, such as a movable platform. The user then marks a first installation point. To mark the next installation point, the user moves the platform, and thus also the extendable pole 310, until one of the laser beams intersects the installation point. When that happens, the other laser beam will indicate the next installation point that is the user-selected distance from the first installation point.

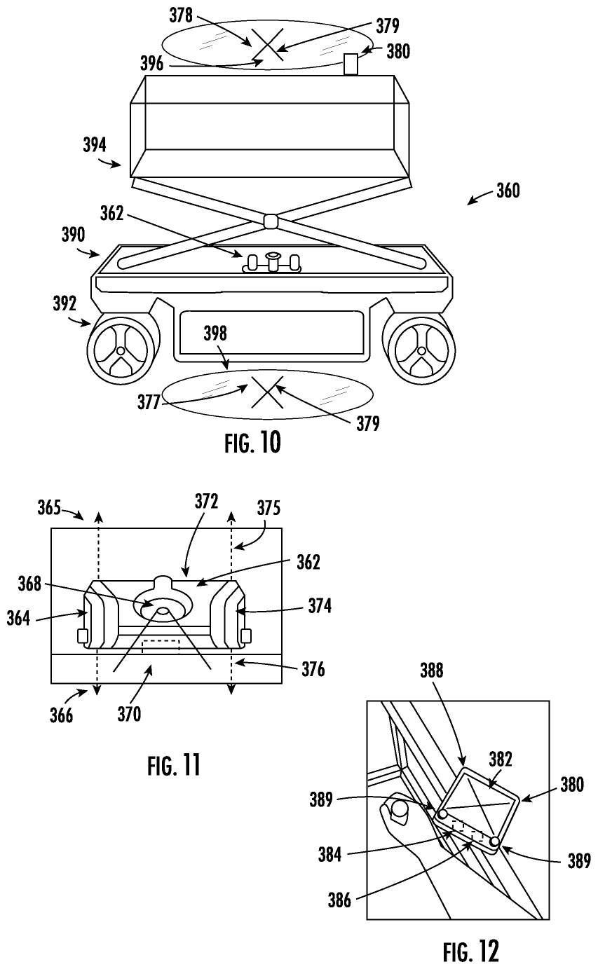

Referring to FIGS. 10-12, laser layout system 360 is shown according to an exemplary embodiment. Laser layout system 360 is substantially the same as laser measuring system 110, laser measuring system 160, and laser measuring system 210 except for the differences discussed herein.

In various embodiments, laser layout system 360 includes first device 362, second device 380, and vehicle 390. In various embodiments, laser layout system 360 includes first device 362 and second device 380. In various embodiments, first device 362 is communicably coupled to second device 380, such as wirelessly communicably connected, such as via WiFi and or Bluetooth®.

First device 362 includes laser generation device 364 and a camera 368. In various embodiments, camera 368 is instead a sensor or detector, such as a visual detector. Camera 368 is configured to capture an image of the first laser beam 366 intersecting the lower surface 398. Laser generation device 364 is configured to emit a first laser beam 366 downward at lower surface 398 and a second laser beam 365 upward at upper surface 396. In various embodiments, first laser beam 366 and second laser beam 365 are the same laser beam, a first portion of which is aimed upward as first laser beam 366, and a second portion of which is aimed upward as second laser beam 365. In various embodiments, first device 362 includes laser generation device 364 and laser generation device 374, each of which are configured to emit laser beams upward and downward. In particular, laser generation device 364 is configured to emit first laser beam 366 downward at lower surface 398 and second laser beam 365 upward at upper surface 396, and laser generation device 374 is configured to emit laser beam 376 downward at lower surface 398 and laser beam 375 upward at upper surface 396.

In various embodiments, first device 362 includes housing 372 and a first coupling mechanism 370, such as a clamp, configured to couple first device 362 to an object, such as base 392 of moveable vehicle 390. In various embodiments, moveable vehicle 390 includes base 392 and platform 394 that vertically actuates above the base 392 between an extended position and a retracted position, and the platform 394 is further above the base 392 in the extended position compared to the retracted position. In various embodiments, first device 362 is coupled to base 392 and second device 380 is coupled to platform 394.

Second device 380 includes display screen 382 and receiver 384. Receiver 384 is configured to receive a signal from first device 362 that is representative of an image captured by the camera 368, and display screen 382 is configured to display the image captured by camera 368 in response to receiving the signal. In various embodiments, receiver 384 receives the signal wirelessly. In various embodiments, receiver 384 receives the signal via WiFi. In various embodiments, second device 380 includes housing 388 and second coupling mechanism 386, such as a clamp, which is configured to couple second device 380 to an object, such as platform 394 of vehicle 390. In various embodiments, second device 380 includes one or more controls 389, which are coupled to housing 388, such as rotatably coupled to housing 388.

In a first exemplary use, first device 362 is configured to adjust the aim of a laser beam (e.g., first laser beam 366, second laser beam 365) in response to the first device 362 receiving a signal (e.g., a second signal, a third signal) from second device 380 so that the laser beam intersects a surface (e.g., lower surface 398, upper surface 396) at a different location. Second device 380 is configured to wirelessly send a signal (e.g., a second signal, a third signal) to first device 362 to adjust a laser beam (e.g., first laser beam 366, second laser beam 365). In various embodiments, first device 362 is configured to adjust the aim of a laser beam (e.g., first laser beam 366, second laser beam 365) in response to first device 362 receiving a signal from second device 380, which is generated in response to a user rotating a control 389. In various embodiments, second device 380 includes rotatable control 389 that causes second device 380 to emit a signal when rotatable control 389 is rotated, thereby causing the first device 362 to adjust the aim of a laser beam (e.g., first laser beam 366, second laser beam 365). In various embodiments, control(s) 389 are configured to control one or more of laser beam 365, laser beam 366, laser beam 375, and/or laser beam 376 via a user rotating control(s) 389, which causes first device 362 to transmit a signal to second device 380, which then adjusts the aim of one or more of laser beam 365, laser beam 366, laser beam 375, and/or laser beam 376. In a specific embodiment, second device 380 includes two controls 389 that are configured to control one or more of laser beam 365, laser beam 366, laser beam 375, and laser beam 376 and/or to toggle between which of laser beam 365, laser beam 366, laser beam 375, and laser beam 376 is being controlled.

In a specific embodiment, first device 362 is configured to adjust the aim of first laser beam 366 in response to first device 362 receiving a second signal from second device 380. In a specific embodiment, first device 362 is configured to adjust the aim of second laser beam 365 in response to first device 362 receiving a third signal from second device 380.

In a second exemplary use, laser beam 366 is emitted downward to a first installation point marked on lower surface 398 (e.g., a floor below base 392 of vehicle 390), and laser beam 365 is emitted upward to a second installation location on upper surface 396 (e.g., a ceiling) that is not marked yet. The first device 362 sends an image captured by camera 368 to second device 380, such as wirelessly. In various embodiments and use cases, the image captured by camera 368 includes first laser beam 366 intersecting lower surface 398.

In various embodiments, first laser beam 366 produces first line 377 on the lower surface 398 when laser beam 366 intersects the lower surface 398, and laser beam 376 produces line 379 on the lower surface 398 when laser beam 376 intersects the lower surface 398 (FIG. 10). In various embodiments, one or more of laser beam 366 and laser beam 376 includes a plane of light (e.g., are emitted as a plane of light). In various embodiments, second laser beam 365 includes a plane of light that produces second line 378 on the upper surface 396 when laser beam 365 intersects the upper surface 396, and laser beam 375 includes a plane of light that produces line 381 on the upper surface 396 when laser beam 375 intersects the upper surface 396 (FIG. 10).

The user aligns laser beam 366 with the target on the floor by watching screen 382 on second device 380. When aligned, the user then marks the second installation point on the ceiling.

In various embodiments, first device 362 includes two single-plane pendulum lasers driven by motors that have a half-silvered mirror, which splits laser beam(s) into an upward projecting laser beam and a downward projecting laser beam. In various embodiments, the camera is a WiFi-enabled camera.

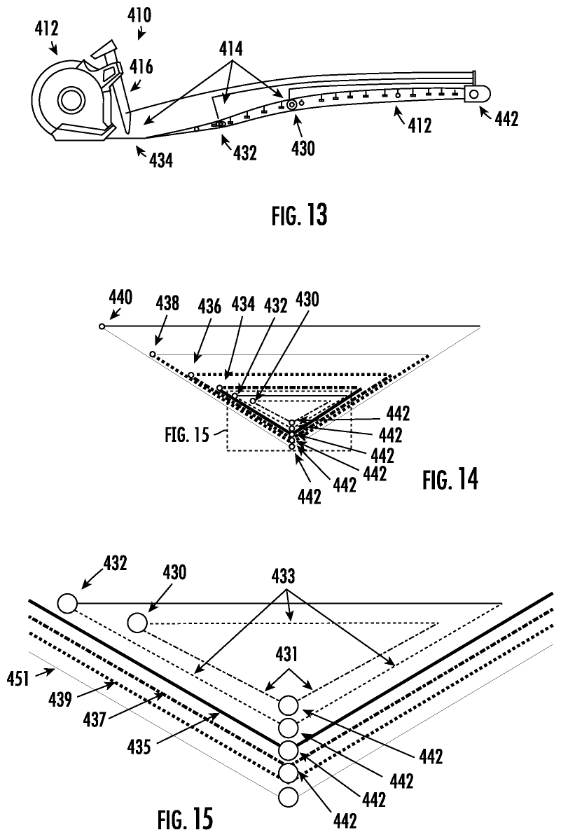

Referring to FIGS. 13-15, measuring device 410 is shown according to an exemplary embodiment. Measuring device 410 facilitates a user marking 45 degree and 90 degree angles, such as can be found in right isosceles triangles.

Measuring device 410 includes tape 412 extending from a housing. The tape 412 includes a plurality of grommets 414 and a securing device 416 configured to extend through one of the grommets 414 when the tape 412 has been extended to the desired length.

In a specific embodiment, first grommet 430 is first distance 431 from end 442, second grommet 432 is second distance 433 from end 442, and second distance 433 corresponds to the distance of the hypotenuse of a right isosceles triangle having sides of distance 431.

Referring to FIGS. 14-15, depicted are various aspects of the measuring device 410 in use. In particular, various dimensions of the grommet distances are overlayed on top of each other for comparison and to demonstrate the relationship between the distances. In particular, it will be observed that each grommet is 2\hat{ }0.5 further from end 442 than the preceding grommet, thereby facilitating the user marking various sized right isosceles triangles.

With reference to FIG. 15, in use the user can mark a first point and then using first grommet 430 the user can mark a second point that is a first distance 431 from the first point. The user can then mark a first arc that is first distance 431 up and to the right from the first point, and the user can mark a second arc from the second point that is directly to the right and second distance 433 from the second point. The intersection of those two arcs is the third point on the right isosceles triangle, thereby enabling the user to mark 90 degree and/or 45 degree angles from the selected points.

In a specific embodiment, first grommet 430 is first distance 431 from end 442, second grommet 432 is second distance 433 from end 442, third grommet 434 is third distance 435 from end 442, fourth grommet 436 is fourth distance 437 from end 442, fifth grommet 438 is fifth distance 439 from end 442, and sixth grommet 440 is first distance 441 from end 442.

In various embodiments, second distance 433 is approximately 41% bigger than first distance 431 (e.g., second distance 433 is 2\hat{ }0.5 longer than first distance 431), third distance 435 is approximately 41% bigger than second distance 433 (e.g., 2\hat{ }0.5 longer), fourth distance 437 is approximately 41% bigger than third distance 435 (e.g., 2\hat{ }0.5 longer), fifth distance 439 is approximately 41% bigger than fourth distance 437 (e.g., 2\hat{ }0.5 longer), sixth distance 45 is approximately 41% bigger than fifth distance 439 (e.g., 2\hat{ }0.5 longer). The term approximately includes distances within 5% of the specified target, or more specifically within 2.5% of the specified target, or more specifically within 1% of the specified target.

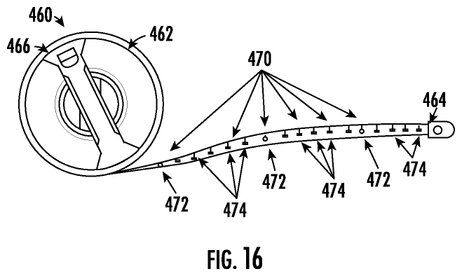

Referring to FIG. 16, measuring device 460 is shown according to an exemplary embodiment. Measuring device 460 includes housing 462, tape 464 extending from housing 462, a plurality of light-emitters 470 coupled to tape 464, and a plurality of input buttons 466 to configure which of light-emitters 470 emit light. In use, the user interacts with buttons 466 to select a first subset 472 of light-emitters 470 that are turned on (e.g., every light that is a multiple of 2.5″ from the end), thus leaving the remaining subset 474 of light-emitters 470 turned off. In this way, the user can dynamically select which interval will be clearly and brightly marked by measuring device 460.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A laser layout system comprising:
a first device comprising a laser generation device and a camera, the laser generation device configured to emit a first laser beam downward at a lower surface and a second laser beam upward at an upper surface; and
a second device comprising a display screen and a receiver, the receiver configured to receive a signal from the first device that is representative of an image captured by the camera, the display screen configured to display the image captured by the camera in response to receiving the signal.

2. The laser layout system of claim 1, wherein the image captured by the camera comprises the first laser beam intersecting the lower surface.

3. The laser layout system of claim 1, wherein the first laser beam produces a first line on the lower surface when the first laser beam intersects the lower surface.

4. The laser layout system of claim 3, wherein the second laser beam produces a second line on the upper surface when the second laser beam intersects the upper surface.

5. The laser layout system of claim 1, comprising a first coupling mechanism configured to couple the first device to a base of a moveable vehicle, the moveable vehicle comprising the base and a platform that vertically actuates above the base between an extended position and a retracted position, wherein the platform is further above the base in the extended position compared to the retracted position.

6. The laser layout system of claim 5, comprising a second coupling mechanism configured to couple the second device to the platform of the moveable vehicle.

7. The laser layout system of claim 1, wherein the receiver receives the signal wirelessly.

8. The laser layout system of claim 7, wherein the receiver receives the signal via WiFi.

9. The laser layout system of claim 1, wherein the first device is configured to adjust an aim of the first laser beam in response to the first device receiving a second signal from the second device.

10. The laser layout system of claim 9, wherein the first device is configured to adjust an aim of the second laser beam in response to the first device receiving a third signal from the second device.

11. A laser layout system comprising:
a first device comprising a laser generation device and a camera, the laser generation device configured to emit a first laser beam downward at a lower surface and a second laser beam upward at an upper surface, the camera configured to capture an image of the first laser beam intersecting the lower surface; and
a second device configured to wirelessly send a signal to the first device to adjust the first laser beam, wherein the first device is configured to adjust the aim of the first laser beam in response to the first device receiving the signal.

12. The laser layout system of claim 11, wherein the first laser beam produces a first line on the lower surface when the first laser beam intersects the lower surface, and wherein the second laser beam produces a second line on the upper surface when the second laser beam intersects the upper surface.

13. The laser layout system of claim 11, wherein the first device is configured to adjust the aim of the first laser beam in response to the first device receiving a second signal from the second device.

14. The laser layout system of claim 11, wherein the first device is configured to adjust the aim of the second laser beam in response to the first device receiving a third signal from the second device.

15. A laser layout system comprising:
a moveable vehicle comprising a base and a platform that vertically actuates above the base between an extended position and a retracted position, wherein the platform is further above the base in the extended position compared to the retracted position;
a first device coupled to the base, the first device comprising a laser generation device configured to emit a first laser beam downward and a second laser beam upward; and
a second device communicably connected with the first device, the second device coupled to the platform.

16. The laser layout system of claim 15, the first device comprising a camera and the second device comprising a display screen and a receiver, the receiver configured to receive a signal from the first device that is representative of an image captured by the camera, the display screen configured to display the image captured by the camera in response to receiving the signal, wherein the image captured by the camera comprises the first laser beam intersecting a lower surface below the base.

17. The laser layout system of claim 16, wherein the receiver receives the signal wirelessly.

18. The laser layout system of claim 17, wherein the receiver receives the signal via WiFi.

19. The laser layout system of claim 16, wherein the first device is configured to adjust the aim of the first laser beam in response to the first device receiving a second signal from the second device.

20. The laser layout system of claim 19, the second device comprising a rotatable control that causes the second device to emit the second signal when the rotatable control is rotated, thereby causing the first device to adjust the aim of the first laser beam.
